(19) United States
(12) Patent Application Publication
(10) Pub. No.: US 2005/0030866 A1
(43) Pub. Date: Feb. 10, 2005

(54) Optical disk drive

(76) Inventors: Hiroaki Ono, Fujisawa (JP); Kyuichirou Nagai, Fujisawa (JP); Manabu Sasamoto, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/846,552

(22) Filed: May 17, 2004

(30) Foreign Application Priority Data
Aug. 8, 2003 (JP) 2003-206641

(51) Int. Cl. G11B 5/09

(52) U.S. Cl. 369/53.21; 369/47.21; 369/59.23

(57) ABSTRACT

To quickly display catalog information on thumbnails and other data stored on an optical disk, management information or catalog information recorded on the optical disk and identification information and history information on the optical disk are stored on a storage other than the optical disk. If, when the optical disk is inserted, the history information or the identification information read from the optical disk matches the history information or the identification information stored on the storage, the management information or the catalog information stored on the storage that has a higher access speed is read and the information is used immediately.

### INCORPORATION BY REFERENCE

The present application claims priority from Japanese patent application JP2003-206641 filed on Aug. 8, 2003, the content of which is hereby incorporated by reference herein.

### BACKGROUND OF THE INVENTION

1. Field of the Invention

The present invention relates to an optical disk and a read/write device that uses it, and more particularly to an optical disk drive that has storage means installed inside or outside the drive.

2. Description of the Related Art

Recently, various systems using optical disk media, which are easy to mass-produce and highly reliable, are marketed. For example, typical products are a digital video disk (hereinafter abbreviated DVD-Video) that is an optical disk for videos such as movies and DVD-ROM that is used with computers for recording application software, game software, and various data. Rewritable optical recording media using optical disks, such as DVD-RAM, DVD±RW, and DVD±R, are also used for recording the backup of personal information and for DVD recorders that are substitutions for VTRs.

To read data from or write data to those optical disk media, the optical disk medium must be mounted on a reader, the optical disk must be rotated until a predetermined rotation speed for reading/writing is reached, and the optical head must be positioned at a predetermined write or read position. Therefore, it takes a long time before the write or read operation is started because the control operation must be performed to rotate a disk until a predetermined rotation speed is reached and the seek/focus/tracking operation must be performed to move the optical head to a predetermined position. Thus, even to simply read recorded contents, for example, information such as disk management information and catalog information on still image or moving image thumbnails, titles, and comment displays, from an optical disk or even to simply write such contents to an optical disk, the control operations described above must be performed before reading or writing them, requiring a long time.

Rewritable optical recording media using optical disks, such as DVD-RAM and DVD±RW, are available for writing backup of personal information to a DVD recorder or a DVD drive for a PC. However, for those optical disks used only for recording, it is also required to rotate the optical disk and, after performing a predetermined control operation, to read the catalog information from the optical disk to check the information written by the user on the optical disk. Therefore, to identify the written contents, the user must either write detailed recorded contents on the label or wait until the optical disk is rotated and a series of disk processing operations are performed so that the information stored on the optical disk can be read. The user thus finds it cumbersome to do so.

In addition, the optical disk media for optical recording described above, though almost similar in shape, have different recording capacities and recording modes. Thus, when using those media, the user must consider their uses and types. In addition, it is impractical to purchase the drives, one for each of those media, from the viewpoint of cost and installation space. To solve this problem, a drive is available that can perform the read/write operation for optical disk media of different read/write types in the same drive. This situation further makes it difficult for the user to efficiently manage optical disk recording media that are of different types and that contain different contents. Furthermore, the user who has a plurality of such optical disks finds it very cumbersome to memorize or put down the titles, the user management information, and the catalog information stored on the optical disks. If the contents of an optical disk are changed, it is almost impossible to identify what is stored on the optical disk. If it is required to insert an optical disk into the optical disk drive and perform a series of operations to check the contents, the disk drive becomes very difficult to use. Therefore, the efficient management of disk information on such a drive is vital.

An example of prior art methods for separately managing information used for information management and content confirmation from the main information is to install a semiconductor memory on an inner part of an optical disk. Laid-open publications related to this example are the following three.
JP-A-5-258347, JP-A-11-250494, JP-A-11-353714

However, because a semiconductor memory is installed on an optical disk in advance and data is supplied to it, the cost is increased. In addition, installing a semiconductor memory on a commercially-available optical disk is difficult because it causes a disk balancing problem.

### SUMMARY OF THE INVENTION

Both read-only optical disks such as DVD-Video, DVD-Audio, and DVD-ROM and writable optical disks such as DVD-RAM, DVD±RW, and DVD±R are media to or from which information is written or read in a non-contact manner using an optical head that uses a laser beam. Therefore, subsequent to replacing an optical disk being loaded with an optical disk, the type of the replaced optical disk is first determined and then the replaced optical disk is rotated, followed by performance of a focusing operation that is required after loading the replaced disk in order to perform a servo learning processing for a precise tracking servo operation. After completing such operations, information can be read from the replaced optical disk.

After that, for a writable optical disk, learning processing for the write system is performed for writing information using an optimum power and, after this processing is terminated, information can be stored on the optical disk.

Next, the management information is read from various locations on the optical disk, the drive becomes ready, and the drive waits for an instruction from the host.

Then, in response to a request from the host, the file management information (for example, UDF) and the catalog information on still image or moving image thumbnails, titles or display of comments are read from the optical disk and, based on the information read, the host displays the information that is stored on the optical disk to the user.

Therefore, after the new optical disk is loaded, it takes at least 10 or more seconds or, in the worst case, several tens of seconds until the information stored on the new optical disk is displayed. Especially, an optical disk which typically has a heavy optical head requires time to move the head to read management information and catalog information that are dispersedly written in various location on the optical disk and, therefore, the larger the contents are recorded, the longer it takes to read the recorded contents.

It is a problem to be solved by the present invention to make it possible to quickly read the disk management information and the catalog information written in the recorded information such as games, application software, music, and movies stored on an optical disk such as DVD-Video, DVD-Audio, and DVD-ROM. It is another problem to be solved by the present invention to provide an optical disk drive that allows the user to easily identify what information has been stored on a rewritable optical recording medium using an optical disk such as DVD-RAM, DVD±RW, and DVD±R for recording the backup of personal information.

To solve the above problems, an optical disk drive according to an aspect of the present invention stores management information or catalog information written on an optical disk, as well as identification information and history information on that optical disk, on storage means other than the optical disk, for example, on large-capacity storage means. When the optical disk is inserted, the history information or the identification information on the optical disk is read. If the history information or the identification information matches the history information or the identification information that was written on the storage means at the same time the management information or the catalog information on the optical disk was written, the information on the optical disk stored on the storage means is read and the management information or the catalog information on the optical disk is sent for immediate display.

When the storage means described above is arranged on a par with the optical disk when viewed from external side such as a host, an external unit such as the host manages the management information or the catalog information stored on the optical disk and the read/write processing of the identification information and the history information on that optical disk. Although the load on the software in the external unit such as the host increases in this case, a change in the hardware can be kept to a minimum because the hardware configuration of the storage means and the optical disk remains unchanged.

Alternatively, the storage means described above is installed within the optical disk drive, and the optical disk drive manages the management information or the catalog information stored on an optical disk and the read/write processing of the identification information and the history information on the optical disk. Although there are some hardware changes in this case because the storage means is installed within the optical disk drive, the optical disk drive can display the management information or the catalog information written on the optical disk more quickly with no consideration for an external unit such as the host.

According to the present invention, when an optical disk is inserted and if the history information or the identification information stored on the optical disk matches the history information or the identification information stored on storage means, the same management information or the catalog information as one stored on the optical disk can be read from the storage means having high accessing speeds for immediate use. With the configuration, various advantages can be obtained, including that information stored on an optical disk can be displayed quickly.

Other objects, features and advantages of the invention will become apparent from the following description of the embodiments of the invention taken in conjunction with the accompanying drawings.

### BRIEF DESCRIPTION OF THE DRAWINGS

FIG. 1 is a system block diagram of one embodiment of the present invention.

FIG. 2 is a system block diagram of another embodiment of the present invention.

FIG. 3 is a system flowchart.

FIG. 4 is another system flowchart.

### DESCRIPTION OF THE EMBODIMENTS

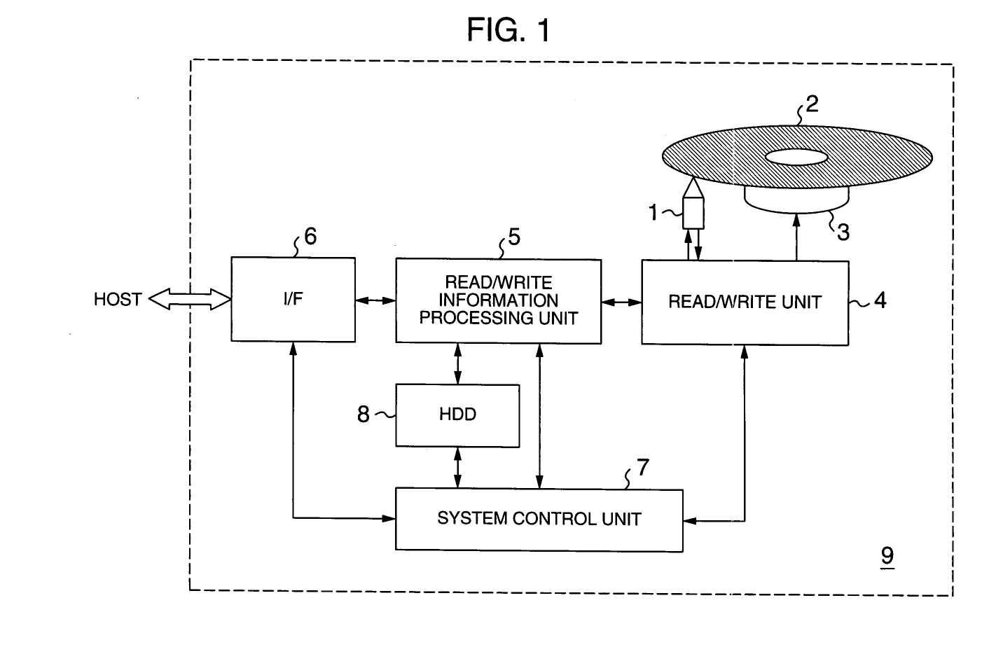

One embodiment of the present invention will be described below with reference to FIGS. 1, 3, and 4.

FIG. 1 shows an overview of the configuration of an optical disk drive 9 in one embodiment of the present invention. In this configuration, a hard disk 8 that is one of storage units is installed inside an optical disk drive (indicated by the broken line in the figure). The numeral 1 indicates an optical head made up of a light emitting device (semiconductor laser) that outputs an optical beam having a predetermined power; a photo acceptance unit (photodiode) that detects a reflected light from an optical disk 2; a half mirror; a collimator lens; a field (object) lens; and an actuator that drives the field lens vertically and radially with respect to the disk surface to control the focus and the track position of the optical beam. The numeral 2 indicates the optical disk, the numeral 3 indicates a spindle motor that rotates the optical disk, and the numeral 4 indicates a read/write unit that writes write data on the optical disk 2 via the optical head 1 or that converts data on the optical disk 2 to electrical signals via the optical head 1 and coverts the signals to read data. The numeral 5 indicates a read/write signal processing unit that converts write information sent from the host to write data that has the format for writing on the optical disk or that performs encode/decode processing, modulation/demodulation, and ECC addition to convert read data read from the optical disk to read information to be sent to the host. The numeral 6 indicates an interface with the host and, via this interface, information to be written or information to be read is transferred to or from the host using a command. The numeral 7 indicates a system control unit that controls and manages all components described above. The numeral 8 indicates the hard disk drive that, in this configuration, transfers write information or read information, or write data or read data conforming to the optical disk format, to or from the read/write signal processing unit 5. Access to the hard disk drive 8 is controlled by the system control unit 7. Therefore, the host does not control the hard disk drive 8.

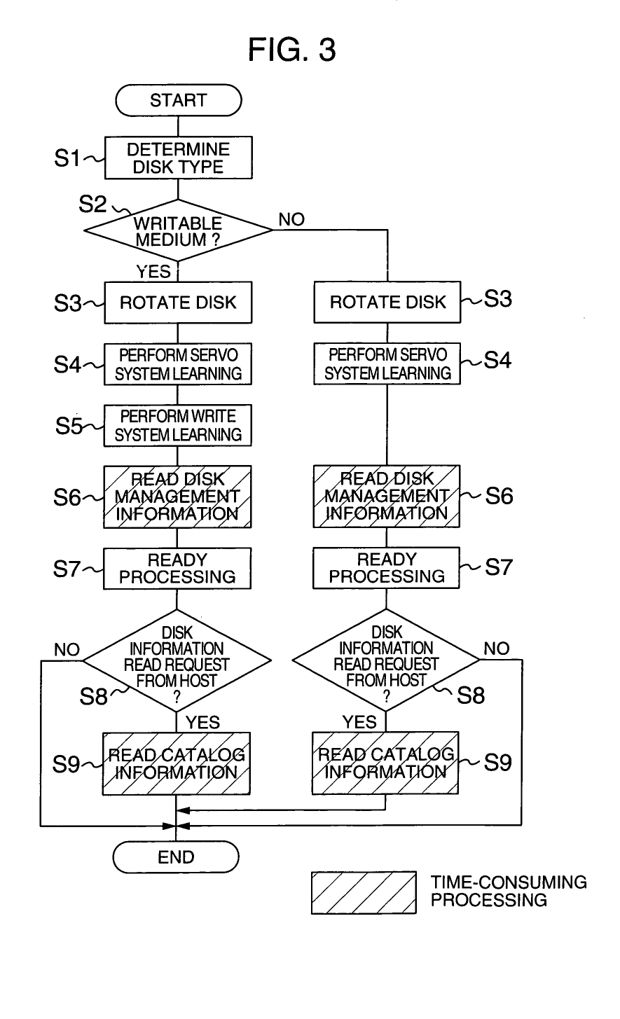

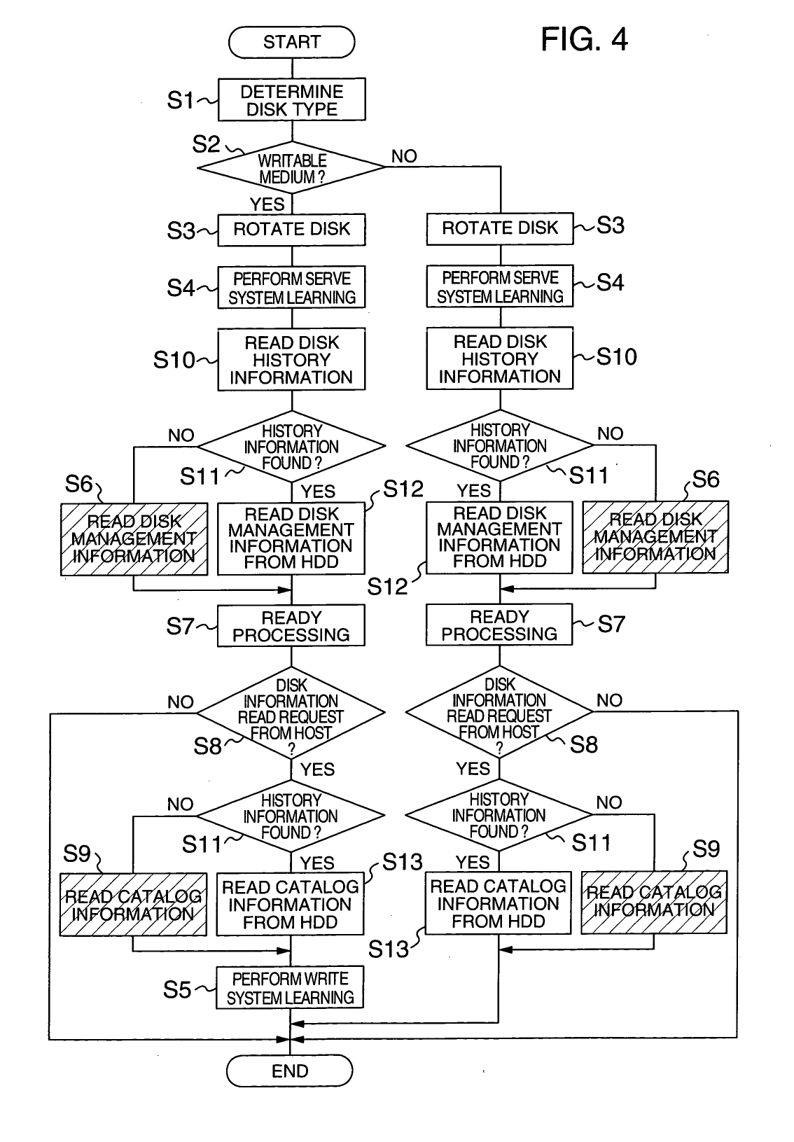

Next, with reference to FIGS. 3 and 4, the sequence of operations of the present invention will be described.

FIG. 3 shows a sequence from the moment an optical disk is inserted into the optical disk drive to the moment the host obtains information stored on the optical disk.

In step 1 (S1) in FIG. 3, the type of an optical disk that is inserted is determined. This is done to determine the type of the optical disk because there are read-only disks such as DVD-Video and DVD-ROM and writable disks such as DVD-RAM, DVD±RW, and DVD±R as described above. In addition to those types, the types of disks such as CD-DA, CD-ROM, CD-R, and CD-RW or Blu-ray disk may be determined.

In step 2 (S2), control is passed to one of the two according to whether the disk is a writable disk. In step 3 (S3), the optical disk is rotated by the spindle motor 3. In step 4 (S4), a laser beam is output, the focus operation that is required after optical disk replacement is performed, the servo learning processing is performed for the precise tracking servo operation, and focus control and tracking control required for reading optical disk address data and write data stored on the optical disk are performed. In this state, the write data and the address data stored on the optical disk can be read. After that, the write system learning processing, shown in step 5 (S5), is performed for a writable optical disk for writing data using an optimum power. After this processing, data can be recorded on the optical disk.

After that, in step 6 (S6), management information, such as DVD-RAM alternate registration information and link point information used for DVD-R and DVD-RW, which is recorded in various location within the optical disk and required in the optical disk, is read. In step 7 (S7), the optical disk drive executes a ready process in which the optical disk drive notifies to the host that the optical disk drive is ready, going into a wait state for an instruction from the host. After that, in accordance with a request from the host, the optical disk drive reads the file management information (such as UDF) and the catalog information from the optical disk. Based on the information read, the host displays information stored on the optical disk to the user.

Note that, because the optical head of the optical disk drive is particularly heavy, it takes a long time for the drive to move the head for reading the management information and the catalog information from various locations on the optical disk. This means that it takes longer time as the volume of contents written on the optical disk becomes larger. In particular, the processing in step 6 (S6) and step 9 (S9) in the figure, where the head moves frequently, is a time consuming processing.

In view of such, in the present invention the disk management information, the file management information (for example, UDF), and the catalog information, which are to be processed in step 6 (S6) and step 9 (S9), is written in advance on the hard disk which is fast in accessing time. Further, the identification information on the optical disk on which the information was written and the history information, such as a time at which information written on the optical disk is written on the optical disk, are also written on both the optical disk and the hard disk. When an optical disk having a matching identification number and history information is inserted into the optical disk drive, the optical disk drive reads the disk management information and the catalog information, not from the optical disk that uses the low-access-speed optical head, but from the high-access-speed hard disk and supplies the information on the optical disk to the host. This gives the user the information on the optical disk very speedily, thus increasing the ease of use.

FIG. 4 shows the sequence of operations according to the present invention from the moment an optical disk is inserted into the optical disk drive to the moment the host obtains information on the optical disk.

In step 1 (S1) in FIG. 4, the type of an optical disk that is inserted is determined. This is done to determine the type of the optical disk because there are read-only disks such as DVD-Video and DVD-ROM and writable disks such as DVD-RAM, DVD±RW, and DVD±R as described above. In addition to those types, the types of disk such as CD-DA, CD-ROM, CD-R, and CD-RW or Blu-ray disk may be determined.

In step 2 (S2), control is passed to one of the two according to whether the disk is a writable disk. In step 3 (S3), the optical disk is rotated by the spindle motor 3. In step 4 (S4), a laser beam is output, the focus operation that is required after the insertion of the optical disk is performed, the servo learning processing is performed for the precise tracking servo operation, and focus control and tracking control required for reading optical disk address data and write data stored on the optical disk are performed. In this state, the write data and the address data on the optical disk can be read. Next, in step 10 (S10), the optical disk identification information and/or history information is read from the optical disk described above.

If an optical disk match occurs as a result of the processing of step 11 (S11) in which a check is made if the identification information and the history information stored on the disk match those stored on the hard disk, the optical disk drive reads the disk management information required in the optical disk drive, such as DVD-RAM alternate registration information and link point information used for DVD-R and DVD-RW, from the hard disk. If there is no matching disk, the optical disk drive reads the disk management information written in various locations within the optical disk in step 6 (S6) as in the conventional drive. After that, the optical disk drive executes ready processing in step 7 (S7), notifies to the host that the optical disk drive is ready, and waits for an instruction from the host.

Next, in response to a request from the host to read the management information (for example, UDF) and the catalog information on the files written on the optical disk, the optical disk drive reads the management information (for example, UDF) and the catalog information on the files on the optical disk from the hard disk as described above if the disk identification information and the history information match those stored on the hard disk in step 11 (S11). Based on the information, the host displays information stored on the optical disk to the user. If there is no matching information, the optical disk drive reads the file management information (for example, UDF) and the catalog information written in various locations on the optical disk as shown in step 9 (S9).

If it is found in the method described above that the disk identification information and the history information stored on the disk match those stored on the hard disk, the management information and the catalog information stored on the hard disk which has fast accessing speeds can be used as substitute for the management information and the catalog information stored on the optical disk. This makes it possible to quickly display user-requested information stored on the optical disk. After that, for a writable optical disk, the write system learning processing is performed in step 5 (S5) for writing data using an optimum power and, after this processing is terminated, data can be written on the optical disk.

Because the hard disk is controlled by the system control unit 7 in the optical disk drive in the method described above, the host can control the hard disk and the optical disk drive without distinction therebetween.

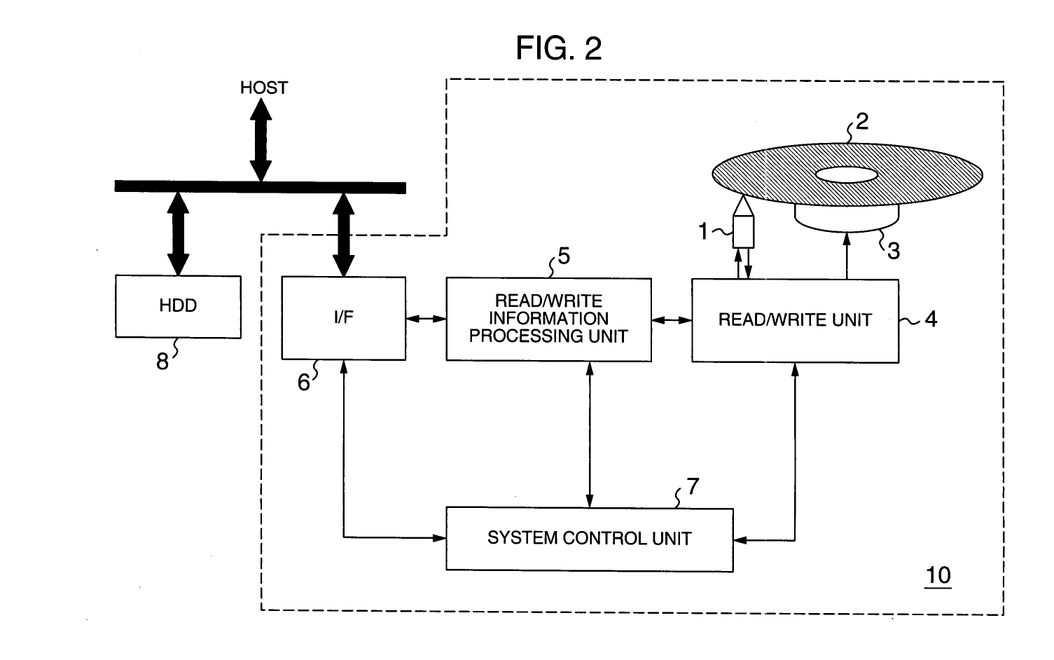

Although the system control unit 7 in the optical disk drive is used to make a host request in the above description, the present invention is not limited to this configuration. For example, the determination in step 11 (S11) in FIG. 4 may be made by the host and the host may perform step 12 (S12) and step 13 (S13). In this case, the hardware configuration is a configuration such as the one shown in FIG. 2.

FIG. 2 shows a schematic diagram of the configuration of an optical disk drive 10 in one embodiment of the present invention. In this configuration, the hard disk drive 8 is installed outside the optical disk drive (indicated by the broken line in the figure) as in a conventional optical disk drive. The numerals 1 to 7 in FIG. 2 are the same as those in FIG. 1. The numeral 8 indicates the hard disk drive and, in this case, the host controls the hard disk. The host controls the optical disk drive and the hard disk while switching the interface 6.

Note that the concept is similar to that of the configuration shown in FIG. 1 in which the hard disk drive 8 is installed inside the optical disk drive 9. The disk management information and the catalog information stored on an optical disk as well as the identification information and the history information on the disk are written also on the hard disk. If the hard disk contains the disk management information and the catalog information on the optical disk for which a match occurs for the identification information and the history information on the optical disk, the host uses this information to cause the user to display it. Because the system control unit 7 does not control the hard disk 8 in this configuration, the optical disk drive can be implemented simply by modifying the control software in the optical disk drive and the software on the host side with no need for a dedicated hardware configuration.

Although the information stored on an optical disk is read only after the optical disk is inserted into the optical disk drive in the above description, the present invention is not limited to this configuration. It is also possible that the catalog information on the optical disks registered with the hard disk in advance is displayed to allow the user to select the necessary data and that the intended optical disk is identified from the disk identification number so that the information may be extracted therefrom.

Although the information stored on an optical disk is written on the hard disk in the above description, the present invention is not limited to this configuration. For example, the information may be written in a semiconductor memory such as a flash memory.

It should be further understood by those skilled in the art that although the foregoing description has been made on embodiments of the invention, the invention is not limited thereto and various changes and modifications may be made without departing from the spirit of the invention and the scope of the appended claims.

1. An optical disk drive comprising:
an information conversion unit which converts information to be written to data that is written on an optical disk or converts data from an optical disk to readable information;
a write unit which writes the data to an optical disk; and
a read unit which reads the data from an optical disk,
wherein management information or catalog information on a plurality of portable optical disks is stored on a storage other than said optical disk.

2. An optical disk drive comprising:
an information conversion unit which converts information to be written to data that is written on an optical disk or converts data from an optical disk to readable information;
a write unit which writes the data to an optical disk; and
a read unit which reads the data from an optical disk,
wherein identification information and history information on a plurality of portable optical disks and management information or catalog information indicated by the history information are stored on a storage other than said optical disk and,
the next time said optical disk is inserted,
history information or identification information on the optical disk is read from the optical disk and,
if the history information or the identification information that is read matches the history information or the identification information stored on said storage that was written when the management information or the catalog information on the optical disk was written previously,
the information stored on said storage is used.

3. An optical disk drive comprising:
an information conversion unit which converts information to be written to data that is written on an optical disk or converts data from an optical disk to readable information;
a write unit which writes the data to an optical disk; and
a read unit which reads the data from an optical disk,
wherein identification information and history information on a plurality of portable optical disks and management information or catalog information indicated by the history information are stored on a storage other than said optical disk and,
the next time said optical disk is inserted,
history information and identification information on the optical disk are read from the optical disk and,
if the history information and the identification information that are read match the history information and the identification information stored on said storage that were written when the management information or the catalog information on the optical disk was written previously,
the information stored on said storage is used.

4. The optical disk drive according to claim 1, wherein said storage is installed inside said optical disk.

5. The optical disk drive according to claim 1, wherein said storage is installed outside said optical disk.

6. The optical disk drive according to claim 1, wherein said storage is a hard disk.

7. The optical disk drive according to claim 2, wherein said storage is installed inside said optical disk.

8. The optical disk drive according to claim 2, wherein said storage is installed outside said optical disk.

9. The optical disk drive according to claim 2, wherein said storage is a hard disk.

10. The optical disk drive according to claim 3, wherein said storage is installed inside said optical disk.

11. The optical disk drive according to claim 3, wherein said storage is installed outside said optical disk.

12. The optical disk drive according to claim 3, wherein said storage is a hard disk.
